(19) United States
(12) Patent Application Publication
(10) Pub. No.: US 2017/0373362 A1
(43) Pub. Date: Dec. 28, 2017

(54) STRUCTURE OF SERPENTINE TRANSMSSION LINE

(71) Applicant: CHUNG YUAN CHRISTIAN UNIVERSITY, Taoyuan City (TW)

(72) Inventor: Guang-Hwa SHIUE, Taoyuan City (TW)

(73) Assignee: CHUNG YUAN CHRISTIAN UNIVERSITY, Taoyuan City (TW)

(21) Appl. No.: 15/236,208

(22) Filed: Aug. 12, 2016

(30) Foreign Application Priority Data
Jun. 27, 2016 (TW) 105120201

(51) Int. Cl. H01P 1/02; H01P 3/00

(52) U.S. Cl. CPC H01P 1/02; H01P 3/00

(57) ABSTRACT

A structure of serpentine transmission line includes a first transmission line and a second transmission line. The first transmission line includes a first line segment, a second line segment and a third line segment. The second transmission line includes a fourth line segment, a fifth line segment and a sixth line segment. The first line segment, the second line segment, the fourth line segment and the fifth line segment extend along a first direction and have a first line width. The third line segment extends along a second direction and is connected to the first line segment and the second line segment. The sixth line segment extends along the second direction and is connected to the fourth line segment and the fifth line segment. Both the third line segment and the sixth line segment have a second line width. The second line width is greater than the first line width.

### CROSS-REFERENCE TO RELATED APPLICATIONS

This non-provisional application claims priority under 35 U.S.C. §119(a) on Patent Application No(s). 105120201 filed in Taiwan, R.O.C. on Jun. 27, 2016, the entire contents of which are hereby incorporated by reference.

### TECHNICAL FIELD

The disclosure relates to a structure of transmission line, more particularly to a structure of a serpentine transmission line.

### BACKGROUND

High frequency electrical products, computer hardware and software adapted for high speed signals and integrated circuits develop rapidly because the age of high speed digitalized communication comes. Therefore, the demands of operation frequencies and frequency bands of signals are increasing. Moreover, the raise of the transmission speed of signals and the demand of minimization of products make layout densities of circuits increase. As a result, signal integrities are affected during the signal transmissions.

### SUMMARY

In one embodiment, the structure of the serpentine transmission line includes a first transmission line and a second transmission line. The first transmission line includes the first line segment, the second line segment and the third line segment. The second transmission line includes the fourth line segment, the fifth line segment and the sixth line segment. All of the first line segment, the second line segment, the fourth line segment and the fifth line segment extend along a first direction and have a first line width. The third line segment extends along a second direction and is electrically connected to the first line segment and the second line segment. The second direction is perpendicular to the first direction. The sixth line segment extends along the second direction and is electrically connected to the fourth line segment and the fifth line segment. Both the third line segment and the sixth line segment have the second line width. The second line width is greater than the first line width. A projection of the third line segment toward the second direction at least partially overlaps a projection of the sixth line segment toward the second direction.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a top view of a structure of a serpentine transmission line in one embodiment;

FIG. 2 is a top view of the structure of the serpentine transmission line in another embodiment;

FIG. 3 is a top view of the structure of the serpentine transmission line in another embodiment;

FIG. 4 is a waveform of far-end crosstalk noise in one embodiment; and

FIG. 5 is a waveform of reflection frequency domain in one embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

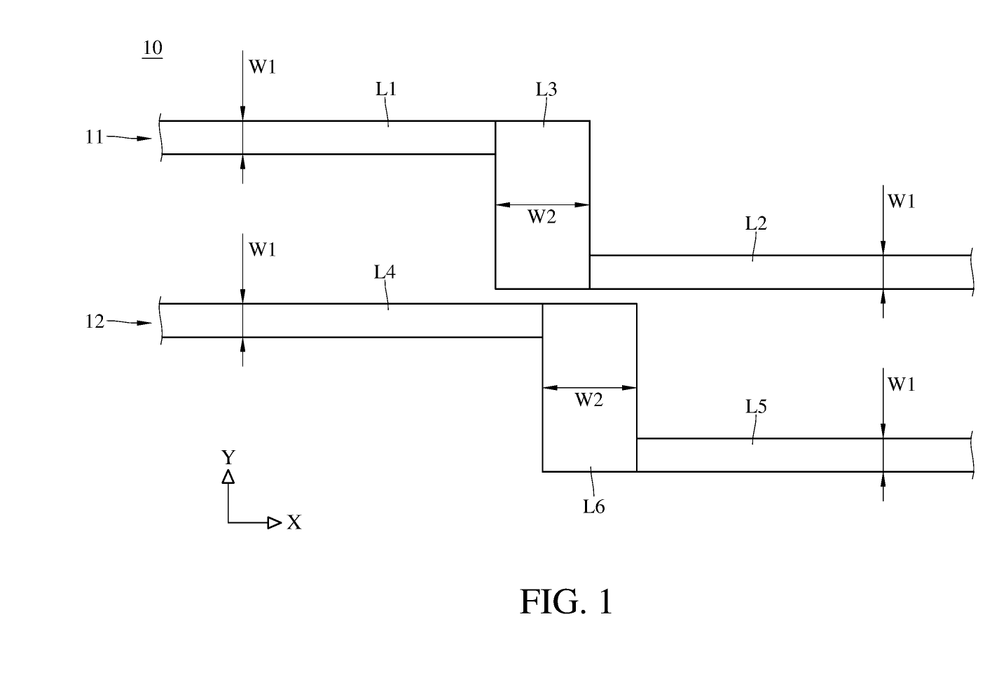

Please refer to FIG. 1. FIG. 1 is a top view of a structure of a serpentine transmission line in one embodiment. As shown in FIG. 1, the structure of the serpentine transmission line 10 includes the first transmission line 11 and the second transmission line 12. The first transmission line 11 includes the first line segment L1, the second line segment L2 and the third line segment L3. The second transmission line includes the fourth line segment L4, the fifth line segment L5 and the sixth line segment L6. In an example, the first transmission line 11 and the second transmission line 12 both are microstrip lines disposed on circuit boards and configured to transmit signals. All of the first line segment L1, the second line segment L2, the fourth line segment L4 and the fifth line segment L5 extend along the first direction (the direction of X axis in FIG. 1) and have a first line width W 1. The third line segment L3 extends along the second direction (the direction of Y axis in FIG. 1) and is electrically connected to the first line segment L1 and the second line segment L2. The second direction is perpendicular to the first direction. The sixth line segment L6 extends along the second direction and is electrically connected to the fourth line segment L4 and the fifth line segment L5. Both the third line segment L3 and the sixth line segment L6 have the second line width W2. The second line width W2 is greater than the first line width W1. A projection of the third line segment L3 toward the second direction partially overlaps a projection of the sixth line segment L6 toward the second direction.

In the structure of the serpentine transmission line of the present disclosure, through the overlapping part of the projection of the third line segment L3 and the projection of the sixth line segment L6 toward the second direction, the first transmission line 11 couples the second transmission line 12 so that the capacitance is increased. Therefore the interference of the far-end crosstalk noise in the second transmission line 12 could be reduced. For example, assume the first transmission line 11 is close to the second transmission line 12. When the signal is transmitted through the first transmission line 11, the far-end crosstalk noise will be generated in the second transmission line 12. At this time, because both the third line segment L3 and the sixth line segment L6 have the second line width W2 and their overlapping part toward the second direction increases the capacitance through the coupling effect, the far-end crosstalk noise in the second transmission line 12 will be reduced. In practice, the distance between the third line segment L3 and the sixth line segment L6 is greater than or equal to the minimum size of manufacturing process in the relative field such as 3 mil. The above embodiments indicating the first line width W1 is one third the second line width W2 are just for illustrating, and the present disclosure is not limited to the line widths.

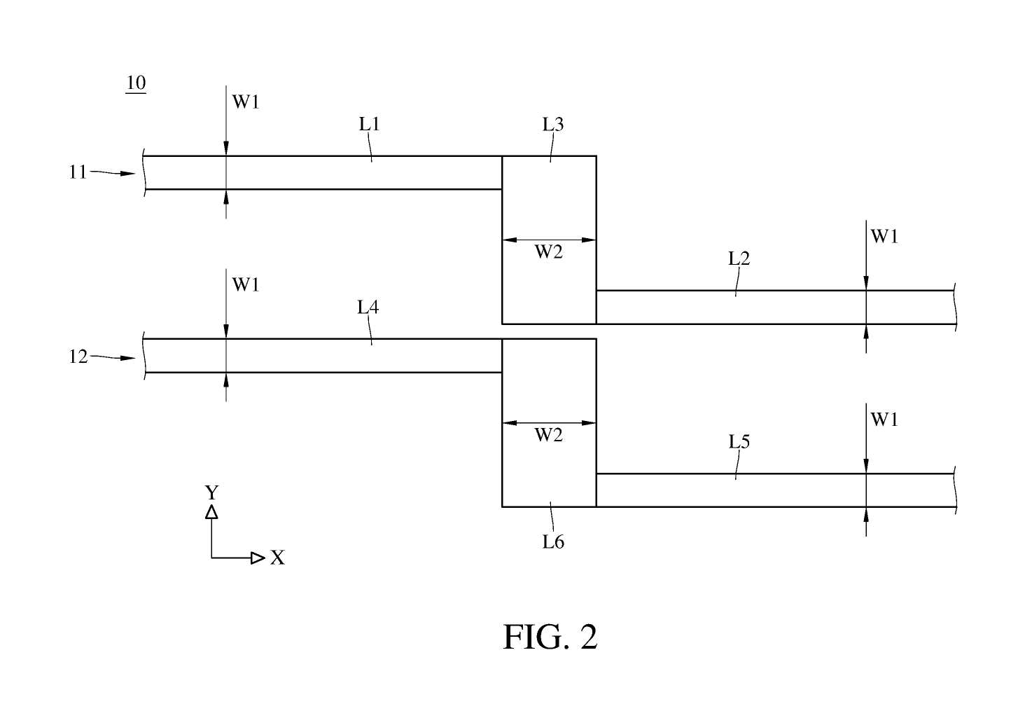

Please refer to FIG. 2. FIG. 2 is a top view of the structure of the serpentine transmission line in another embodiment. The structure of the embodiment in FIG. 2 is approximately the same as the structure of the embodiment in FIG. 1. The difference between the structure of the embodiment in FIG. 2 and the structure of the embodiment in FIG. 1 is the overlapping part between the projection of the third line segment L3 toward the second direction and the projection of the sixth line segment L6 toward the second direction. As shown in FIG. 2, since the projection of the third line segment L3 toward the second direction fully overlaps the projection of the sixth line segment L6 toward the second direction, the effects of coupling in the embodiment of FIG. 2 are more significant than in the embodiment of FIG. 1 so that the capacitance is raised and the far-end crosstalk noise is decreased effectively. In another embodiment, both the first transmission line 11 and the second transmission line 12 include a plurality of line segments extending along the second direction, and projections of corresponding ones among the line segments toward the second direction overlap each other so that the capacitance could be raised significantly. Therefore the far-end crosstalk noise is decreased significantly.

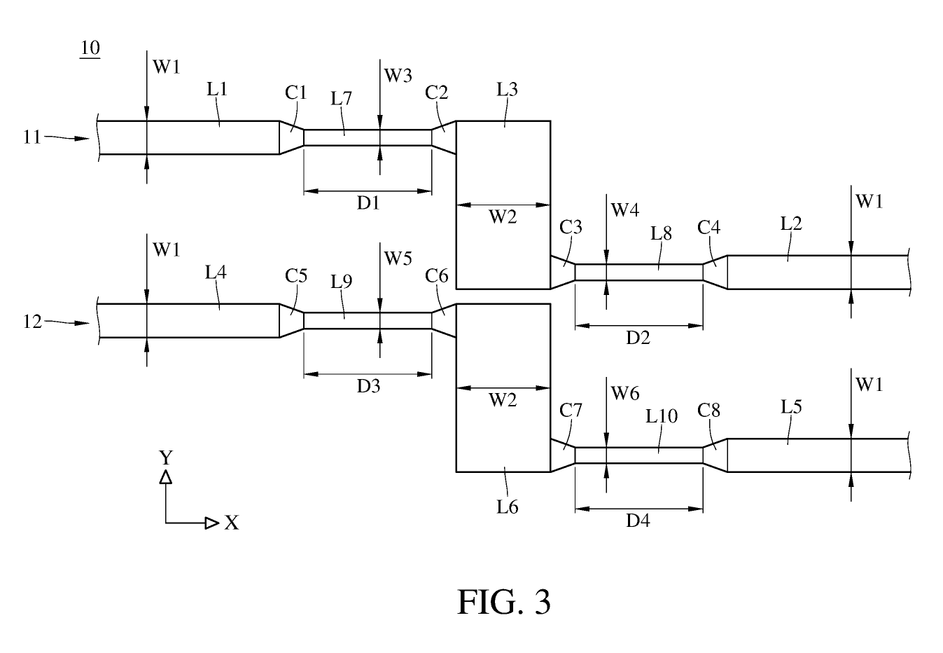

Please refer to FIG. 3. FIG. 3 is a top view of the structure of the serpentine transmission line in another embodiment. Comparing to the embodiments in FIG. 1 and FIG. 2, the first transmission line 11 in the embodiment in FIG. 3 further includes the seventh line segment L7 and the eighth line segment L8. The seventh line segment L7 is electrically connected to the first line segment L1 and the third line segment L3. The eighth line segment L8 is electrically connected to the second line segment L2 and the third line segment L3. The seventh line segment L7 has a third line width W3, and the eighth line segment L8 has a fourth line width W4. The third line width W3 and the fourth line width W4 both are less than the first line width W1.

In one embodiment, the first transmission line 11 further includes the first connector C1 respectively connected to the first line segment L1 and the seventh line segment L7. The second connector C2 is respectively connected to the third line segment L3 and the seventh line segment L7. The third connector C3 is respectively connected to the third line segment L3 and the eighth line segment L8. The fourth connector C4 is respectively connected to the second line segment L2 and the eighth line segment L8. All of the first connector C1, the second connector C2, the third connector C3 and the fourth connector C4 are trapezoids. Note that those said connectors having the shapes of trapezoids are configured to smoothly connect line segments having different line widths so that the discontinuities of the transmission line caused by the differences of line widths could be avoided. The present disclosure is not limited to trapezoids. The present disclosure covers any type of shapes smoothly connecting the line segments having different line widths. In one embodiment, the greater the length of the first connector C1 is, the greater the difference between the first line width W1 of the first line segment L1 and the third line width W3 of the seventh line segment L7 is. The greater the difference between the first line width W1 of the second line segment L2 and the fourth line width W4 of the eighth line segment L8 is, the greater the length of the fourth connector C4 is.

TABLE 1

| W1 | W3 | W4 | W5 | W6 |
|---|---|---|---|---|
| 6 (mil) | 3 (mil) | 3 (mil) | 3 (mil) | 3 (mil) |
| W2 | D1 | D2 | D3 | D4 |
| 18 (mil) | 24 (mil) | 24 (mil) | 24 (mil) | 24 (mil) |

In one embodiment, the third line width W3 of the seventh line segment L7 is one eighth the length D1 of the seventh line segment L7. The fourth line width W4 of the eighth line segment L8 is one eighth the length D2 of the eighth line segment L8. For example, as shown in table 1, when the length D1 of the seventh line segment L7 and the length D2 of the eighth line segment L8 both are 24 mil, the third line width W3 of the seventh line segment L7 and the fourth line width W4 of the eighth line segment L8 both are 3 mil. The unit “mil” refers to a thousandth of an inch. The line widths and the lengths mentioned in the above embodiments are just for illustrating, and the present disclosure is not limited to it.

The second transmission line 12 further includes a ninth line segment L9 and a tenth line segment L10. The ninth line segment L9 is electrically connected to the fourth line segment L4 and the sixth line segment L6. The tenth line segment L10 is electrically connected to the fifth line segment L5 and the sixth line segment L6. The ninth line segment L9 has a fifth line width W5, and the tenth line segment L10 has the sixth line width W6. The fifth line width W5 and the sixth line width W6 both are less than the first line width W1.

In one embodiment, the second transmission line 12 further includes the fifth connector C5 respectively connected to the fourth line segment L4 and the ninth line segment L9. The sixth connector C6 is respectively connected to the sixth line segment L6 and the ninth line segment L9. The seventh connector C7 is respectively connected to the sixth line segment L6 and the tenth line segment L10. The eighth connector C8 is respectively connected the fifth line segment L5 and the tenth line segment L10. All of the fifth connector C5, the sixth connector C6, the seventh connector C7 and the eighth connector C8 are trapezoids. In one embodiment, the greater the difference between the first line width W1 of the fourth line segment L4 and the fifth line width W5 of the ninth line segment L9 is, the greater the length of the fifth connector C5 is. The greater the difference between the first line width W1 of the fifth line segment L5 and the sixth line width W6 of the tenth line segment L10 is, the greater the length of the eighth connector C8 is.

In one embodiment, the fifth line width W5 of the ninth line segment L9 is one eighth the length D3 of the ninth line segment L9, and the sixth line width W6 of the tenth line segment L10 is one eighth the length D4 of the tenth line segment L10. For example, as shown in table 1, when the length D3 of the ninth line segment L9 and the length D4 of the tenth line segment L10 both are 24 mil, the fifth line width W5 of the ninth line segment L9 and the sixth line width W6 of the tenth line segment L10 both are 3 mil. The ratios regarding the line widths and the lengths mentioned in the above embodiments are just for illustrating, and the present disclosure is not limited to it. In one embodiment, the first line width W1 is one third the second line width W2. For example, as shown in table 1, if the first line width W1 is 6 mil, then the second line width W2 is 18 mil.

As previously mentioned, in the embodiment of FIG. 3, the projection of the third line segment L3 toward the second direction fully overlaps the projection of the sixth line segment L6 toward the second direction so that the coupling effect increases the capacitance and the far-end crosstalk noise is decreased. Nevertheless the increase of the capacitance would make the impedances unmatched. Specifically, the impedances are inversely proportional to the capacitance. Thus, if the inductance is fixed, the impedances will decrease when the capacitance increases so that the impedances are unmatched. The input signal of the transmission line will be affected by reflections when the impedances are unmatched. At this time, the input signal will turn into a standing waveform in the transmission line so that the effective power capacity of the transmission line decreases. Therefore, in one embodiment of the present disclosure, the inductance could be raised by decreasing widths of line segments so that the unmatched impedances are eliminated.

For a practical example, in the embodiment of FIG. 3, the seventh line segment L7 of the first transmission line 11 has the third line width W3, and the eighth line segment L8 of the first transmission line 11 has the fourth line width W4. The third line width W3 and the fourth line width W4 both are less than the first line width W1. When the projection of the third line segment L3 toward the second direction fully overlaps the projection of the sixth line segment L6 toward the second direction so that the coupling effects increase the capacitance, the inductance will increase through the seventh line segment L7 having the third line width W3 and the eighth line segment L8 having the fourth line width W4 so that the unmatched impedances of the first transmission line 11 would become matched. The third line width W3 of the seventh line segment L7 is the same as the fourth line width W4 of the eighth line segment L8. In another embodiment, the third line width W3 of the seventh line segment L7 is different from the fourth line width W4 of the eighth line segment L8. Similarly, the ninth line segment L9 of the second transmission line 12 has the fifth line width W5, and the tenth line segment L10 of the second transmission line 12 has the sixth line width W6. The fifth line width W5 and the sixth line width W6 both are less than the first line width W 1. Through the ninth line segment L9 having the fifth line width W5 and the tenth line segment L10 having the sixth line width W6, the inductance is raised so that the impedances of the second transmission line 12 become matched.

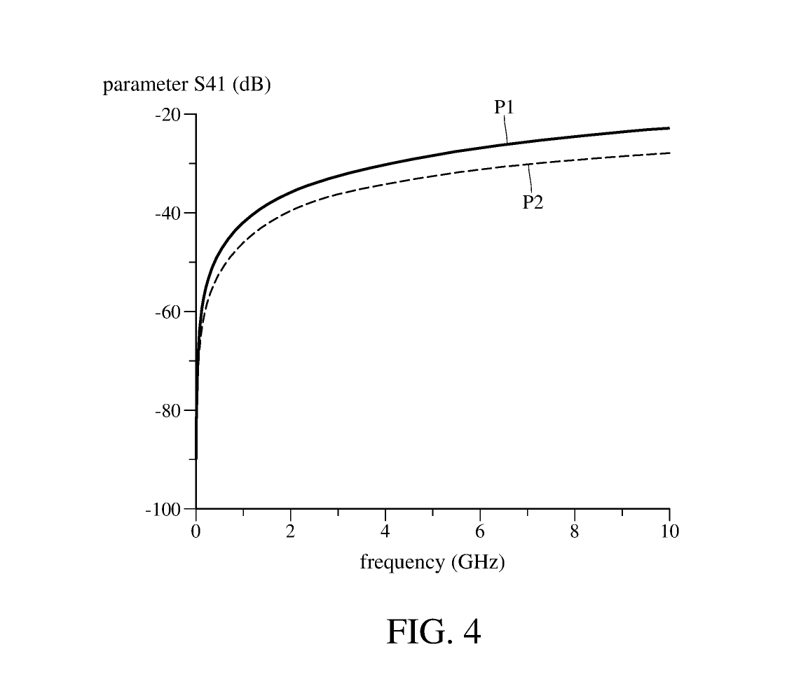

Please refer to FIG. 3 and FIG. 4. FIG. 4 is a waveform of far-end crosstalk noise in one embodiment. As shown in FIG. 4, a parameter S41 is configured to indicate the far-end crosstalk noise, and its equation is expressed as:

$$S 41 = 20 log \vert \frac{V 4}{V 1} \vert$$

A voltage V1 represents an input signal to the first transmission line 11, and the voltage V4 represents a voltage of the far-end crosstalk noise in the second transmission line 12. As indicated in the above equation, the greater the voltage V4 is, the greater the parameter S41 is. The closer the curve is to the top of FIG. 4, the greater the far-end crosstalk noise is. As shown in FIG. 4, the curve P1 represents the variance of the parameter S41 based on a linear structure of a transmission line having the first transmission line 11 and the second transmission line 12 disposed in parallel (without line segments extending along the second direction). The curve P2 represents the variance of the parameter S41 based on the structure of the transmission line in the embodiment of FIG. 3. As shown in FIG. 3, the curve P2 is below the curve P1. In other words, the far-end crosstalk noise of the structure of the transmission line in the embodiment of FIG. 3 is less than the far-end crosstalk noise of the linear structure of the transmission line having the first transmission line 11 and the second transmission line 12 disposed in parallel. In one embodiment, the structure of the transmission line in the embodiment of FIG. 3 further includes more line segments extending along the second direction corresponding to a curve (not shown in FIG. 3 and FIG. 4) below the curve P2. In other words, the more line segments extending along the second direction the structure of the transmission line could includes, the more significantly the far-end crosstalk noise could be reduced.

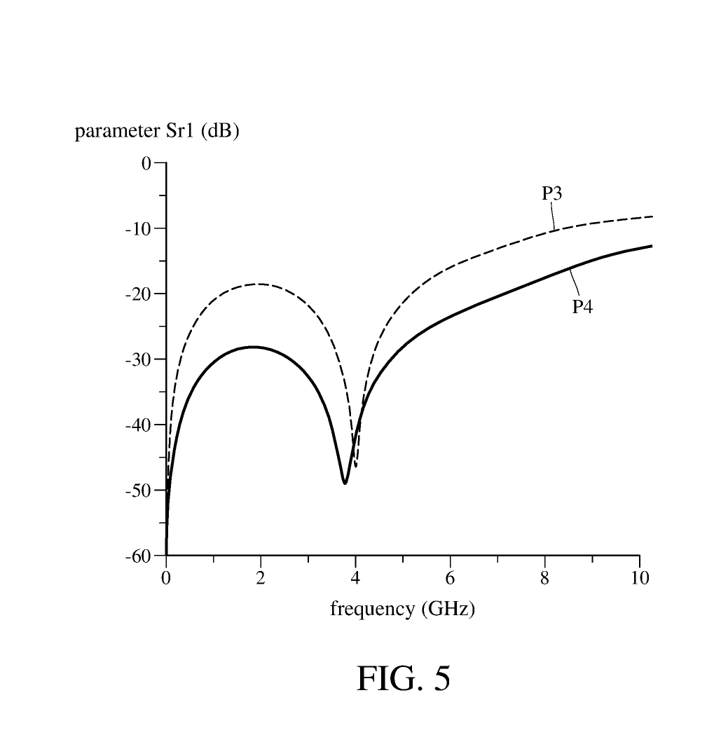

Please refer to FIG. 3 and FIG. 5. FIG. 5 is a waveform of reflection frequency domain in one embodiment. As shown in FIG. 5, the parameter Sr1 represents the reflection of signal in the first transmission line 11, and its equation is expressed as:

$$S r 1 = 20 log \vert \frac{Vr}{V 1} \vert$$

A voltage V1 represents a input signal voltage to the first transmission line 11, and the voltage Vr represents a reflecting signal voltage in the first transmission line 11. During the signal transmission, the weaker the signal reflection is, the more significantly the impedances could be matched. On the contrast, the stronger the signal reflection is, the more significantly the impedances could be unmatched. As indicated in the above equation, the greater the voltage Vr is, the greater the parameter Sr1 is. In the other words, the closer the curve could be to the top of FIG. 5, the more significantly the impedances could be unmatched. As shown in FIG. 5, the curve P3 represents the variance of parameter Sr1 based on the structure of the transmission line in the embodiment of FIG. 2. The curve P4 represents the variance of the parameter Sr1 based on the structure of the transmission line in the embodiment of FIG. 3. As shown in FIG. 5, the curve P4 is below the curve P3. It means that the signal reflection in the structure of the transmission line in the embodiment of FIG. 3 is less than the signal reflection in the structure of the transmission line in the embodiment of FIG. 2. In the other words, the impedances of the structure of the transmission line in the embodiment of the FIG. 3 are more matched than the impedances of the structure of the transmission line in the embodiment of the FIG. 2.

Based on the description above, in the structure of the serpentine transmission line, through the increase of the coupling effects generated by the widths of the line segments extending along the second direction, the capacitance is raised so that the interference of the far-end crosstalk noise is reduced. Through decreasing the widths of the line segments connected to the line segments extending along the second direction, the inductance is raised and the impedances become matched. Therefore the signal integrity is improved during the signal transmissions.

What is claimed is:

1. A structure of a serpentine transmission line, comprising:
a first transmission line, comprising:
a first line segment extending along a first direction;
a second line segment extending along the first direction; and
a third line segment extending along a second direction perpendicular to the first direction and electrically connected to the first line segment and the second line segment; and
a second transmission line, comprising:
a fourth line segment extending along the first direction;
a fifth line segment extending along the first direction; and
a sixth line segment extending along the second direction and electrically connected to the fourth line segment and the fifth line segment;
wherein all of the first line segment, the second line segment, the fourth line segment and the fifth line segment have a first line width, both the third line segment and the sixth line segment have a second line width, the second line width is greater than the first line width, and a projection of the third line segment toward the second direction at least partially overlaps a projection of the six line segment toward the second direction.

2. The structure of the serpentine transmission line according to claim 1, wherein the first transmission line further comprises:
a seventh line segment respectively and electrically connected to the first line segment and the third line segment; and
an eighth line segment respectively and electrically connected to the second line segment and the third line segment;
wherein the seventh line segment has a third line width, the eighth line segment has a fourth line width, and both the third line width and the fourth line width are less than the first line width.

3. The structure of the serpentine transmission line according to claim 2, wherein the first line width is one third the second line width.

4. The structure of the serpentine transmission line according to claim 2, wherein the first transmission line further comprises:
a first connector respectively connected to the first line segment and the seventh line segment;
a second connector respectively connected to the third line segment and the seventh line segment;
a third connector respectively connected to the third line segment and the eighth line segment; and
a fourth connector respectively connected to the second line segment and the eighth line segment;
wherein all of the first connector, the second connector, the third connector and the fourth connector are trapezoids.

5. The structure of the serpentine transmission line according to claim 4, wherein the first line width is one third the second line width.

6. The structure of the serpentine transmission line according to claim 4, wherein a line width of the seventh line segment is one eighth a length of the seventh line segment, and a line width of the eighth line segment is one eighth a length of the eighth line segment.

7. The structure of the serpentine transmission line according to claim 6, wherein the first line width is one third the second line width.

8. The structure of the serpentine transmission line according to claim 1, wherein the second transmission line further comprises:
a ninth line segment respectively and electrically connected to the fourth line segment and the six line segment; and
a tenth line segment respectively and electrically connected to the fifth line segment and the sixth line segment;
wherein the ninth line segment has a fifth line width, the tenth line segment has a sixth line width, and both the fifth line width and the sixth line width are less than the first line width.

9. The structure of the serpentine transmission line according to claim 8, wherein the first line width is one third the second line width.

10. The structure of the serpentine transmission line according to claim 8, wherein the second transmission line further comprises:
a fifth connector respectively connected to the fourth line segment and the ninth line segment;
a sixth connector respectively connected to the sixth line segment and the ninth line segment;
a seventh connector respectively connected to the sixth line segment and the tenth line segment; and
a eighth connector respectively connected to the fifth line segment and the tenth line segment;
wherein all of the fifth connector, the sixth connector, the seventh connector and the eighth connector are trapezoids.

11. The structure of the serpentine transmission line according to claim 10, wherein the first line width is one third the second line width.

12. The structure of the serpentine transmission line according to claim 10, wherein a line width of the ninth line segment is one eighth a length of the ninth line segment and a line width of the tenth line segment is one eighth a length of the tenth line segment.

13. The structure of the serpentine transmission line according to claim 12, wherein the first line width is one third the second line width.

14. The structure of the serpentine transmission line according to claim 1, wherein the first line width is one third the second line width.
